(19) United States
(12) Patent Application Publication
(10) Pub. No.: US 2010/0228931 A1
(43) Pub. Date: Sep. 9, 2010

(54) MANAGEMENT APPARATUS, SYSTEM, CONTROL METHOD, AND RECORDING MEDIUM

(75) Inventor: Fumio Mikami, Chigasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/715,683

(22) Filed: Mar. 2, 2010

(30) Foreign Application Priority Data
Mar. 9, 2009 (JP) 2009-055724

(51) Int. Cl. G06F 12/00; G06F 12/02

(52) U.S. Cl. 711/154; 711/170; 711/E12.001; 711/E12.002

(57) ABSTRACT

The present invention provides a management apparatus that can control a connection of each image forming apparatus to a network so as to maintain a function (capacity) of a big box formed by a plurality of image forming apparatuses.

### BACKGROUND OF THE INVENTION

1. Field of the Invention

The present invention relates to a management apparatus, a system, a control method, and a recording medium.

2. Description of the Related Art

With the trend towards the digitization of image forming apparatuses such as MFPs (Multi Function Printers), a storage apparatus (e.g., a hard disk) is mounted in such an image forming apparatus and is used as a temporary storage area (storage box) for image data. Note that a storage box is generally opened to the user to allow him/her to store (save) data in part of the box.

In addition, with the recent growing trend toward networking of image forming apparatuses, users have been provided with environments (systems) in which each user can arbitrarily use a plurality of image forming apparatuses connected to a network. However, an arrangement in which a plurality of image forming apparatuses connected to a network respectively include independent storage boxes has at least three drawbacks, as will be described below.

The first drawback is that since the storage box in each of a plurality of image forming apparatuses has a fixed capacity, a limitation is imposed on the storable data capacity (folder size or file size) of each image forming apparatus.

The second drawback is that since the user needs to recognize which data (file) is saved in the storage apparatus of which image forming apparatus of the plurality of image forming apparatuses, the convenience for the user deteriorates.

The third drawback is that in order to increase the capacity of each storage box, each of the plurality of image forming apparatuses must be equipped with a large-capacity storage apparatus, resulting in the prolongation of the starting time of each image forming apparatus and an increase in the cost of each image forming apparatus.

Under the circumstances, Japanese Patent Laid-Open Nos. 2002-215347 and 9-22398 have proposed a technique of integrating the storage boxes of the respective image forming apparatuses connected to a network to make the storage boxes be seen as one storage box (virtual storage area) on the network (i.e., sharing of the storage area). This technique handles the respective storage boxes of a plurality of image forming apparatuses connected to a network as one large-capacity storage box (big box) in the overall system. Therefore, any image forming apparatus can access the big box, and the user need not recognize which data is saved in the storage apparatus of which image forming apparatus. This can improve the convenience for the users. In addition, since the big box is formed in the overall system, no limitation is imposed on the storable data capacity of each image forming apparatus. This makes it possible to suppress the prolongation of starting time and an increase in cost due to large-capacity storage apparatuses.

According to the prior art, however, when a given one of image forming apparatuses which provide a storage area as a big box is set in a power saving state or power off state, no user can access the storage apparatus of the image forming apparatus in such a state. As a consequence, the storage area in the system cannot function as a big box. In other words, if a given image forming apparatus functions as part of a big box, in order to maintain the function of the big box, the apparatus is not allowed to be set in a state (power saving state or power off state) in which other image forming apparatuses cannot access the storage apparatus. For power saving or maintenance, in particular, the user often wants to set the image forming apparatus in the power saving state or power off state. The inability to set the power saving state or power off state poses a serious problem.

### SUMMARY OF THE INVENTION

The present invention provides a technique of allowing a given storage apparatus to disconnect from a network while maintaining the function of one virtual storage area formed by a plurality of storage apparatuses on the network.

According to one aspect of the present invention, there is provided a management apparatus that manages a plurality of storage apparatuses connected to a network, the apparatus comprising: a management unit configured to form one virtual storage area on the network from storage areas which are configured to be respectively provided by the plurality of storage apparatuses and manage the virtual storage area; a detection unit configured to detect a stop request to stop at least one of the plurality of storage apparatuses from providing a storage area managed as part of the virtual storage area; a determination unit configured to determine, when the detection unit detects the stop request, whether a storage area provided as part of the virtual storage area by the storage apparatus which has issued the stop request is configured to be allocated to a storage area which is configured to be provided by another storage apparatus; and a control unit configured to perform control to permit the storage apparatus which has issued the stop request to stop providing the storage area when the determination unit determines that the storage area is configured to be allocated and to prohibit the storage apparatus which has issued the stop request from stopping providing the storage area when the determination unit determines that the storage area is not configured to be allocated.

Further aspects of the present invention will become apparent from the following description of exemplary embodiments with reference to the attached drawings.

### BRIEF DESCRIPTION OF THE DRAWINGS

FIG. 1 is a view showing the arrangement of an image forming system according to an aspect of the present invention.

FIG. 2 is a schematic block diagram showing the arrangement of an image forming apparatus in the image forming system shown in FIG. 1.

FIG. 3 is a view for explaining control of power supply by a power supply unit in the image forming system shown in FIG. 1.

FIG. 4 is a schematic block diagram showing an example of the arrangement of a management apparatus in the image forming system shown in FIG. 1.

FIG. 5 is a block diagram showing the function arrangement implemented by the management apparatus (the components ranging from the CPU to the system bus shown in FIG. 4) in the image forming system shown in FIG. 1.

FIG. 6 is a view showing storage areas which can be provided as a big box in the hard disks of a plurality of image forming apparatuses.

FIG. 7 is a view showing an example of the big box formed by the storage areas which can be respectively provided by a plurality of image forming apparatuses.

FIG. 8 is a view showing a state in which one of a plurality of image forming apparatuses is disconnected from a network.

FIGS. 9A and 9B are flowcharts for explaining processing in a management apparatus which is associated with the management of the image forming apparatuses.

FIG. 10 is a flowchart for explaining processing in an image forming apparatus which corresponds to the processing in the management apparatus shown in FIGS. 9A and 9B.

FIGS. 11A to 11D are views each showing an example of a management table created and updated by the management apparatus in the image forming system shown in FIG. 1.

FIG. 12 is a flowchart for explaining processing in the management apparatus that is associated with the restoration of an image forming apparatus, which has been disconnected from the network, to the normal state.

FIGS. 13A and 13B are flowcharts for explaining processing in the management apparatus when the image forming apparatuses are grouped in accordance with the capacities of the storage areas that can be provided as a big box.

FIGS. 14A to 14D are views each showing an example of a management table created and updated by the management apparatus in the image forming system shown in FIG. 1.

FIG. 15 is a view for explaining the ratio between a use area and a preliminary area in each image forming apparatus.

FIG. 16 is a view for explaining the ratio between a use area and a preliminary area in each image forming apparatus.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

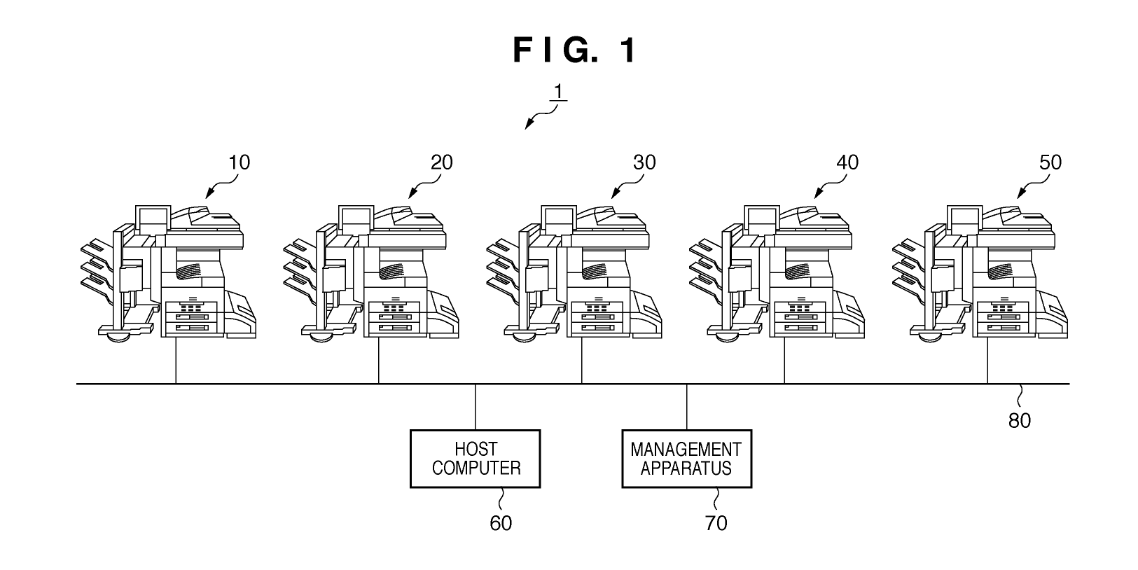

FIG. 1 is a view showing the arrangement of an image forming system 1 according to an aspect of the present invention. The image forming system 1 includes image forming apparatuses 10, 20, 30, 40, and 50, a host computer 60, and a management apparatus (management server) 70. The image forming apparatuses 10 to 50, the host computer 60, and the management apparatus 70 are connected to a network 80 such as a LAN. Note, however, that the arrangement of the image forming system 1 shown in FIG. 1 is merely exemplary and does not limit the numbers of image forming apparatuses, host computers, and management apparatuses which are to be connected to the network 80.

The image forming apparatuses 10 to 50 include various types of image forming apparatuses such as copying machines and printers. In this embodiment, each apparatus is embodied by a multi function printer (MFP) having multi functions such as a copier function, a printer function, and a scanner function. Although the image forming apparatuses 10 to 50 in this embodiment are the same type of image forming apparatuses (for example, MFPs), they may be different types of image forming apparatuses. Note that since the image forming apparatuses 10 to 50 have the same arrangement, the image forming apparatus 10 will be exemplarily described below.

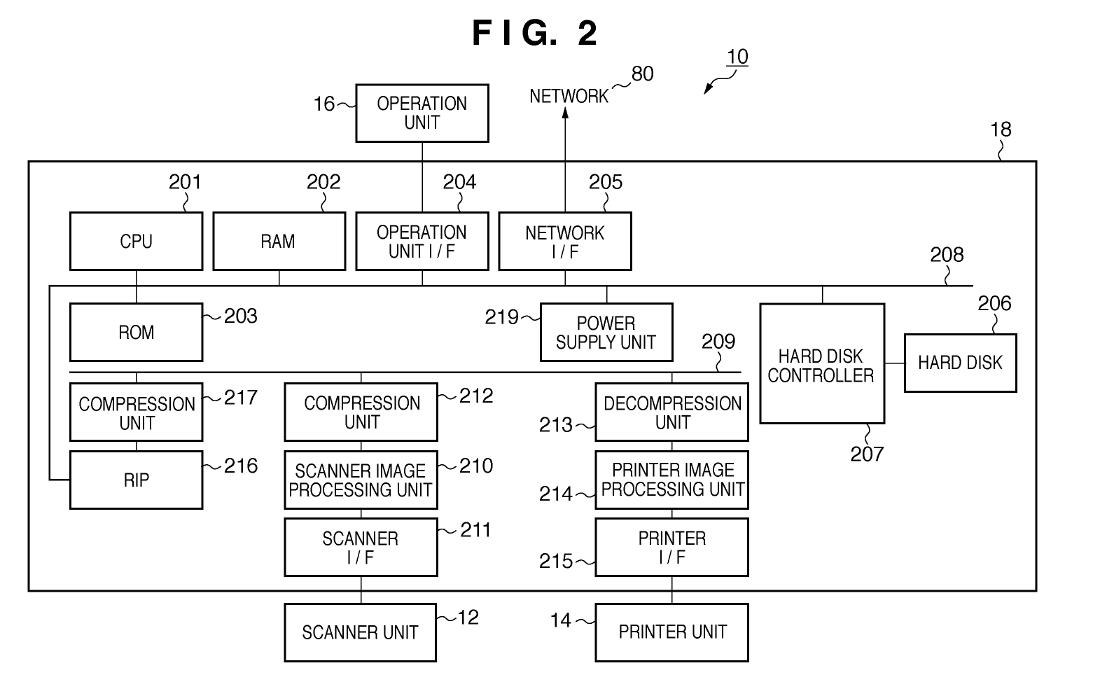

FIG. 2 is a schematic block diagram showing the arrangement of the image forming apparatus 10. As shown in FIG. 2, the image forming apparatus 10 includes a scanner unit 12 as an image input device, a printer unit 14 as an image output device, an operation unit 16, and a control unit 18.

The scanner unit 12 performs read operation in accordance with a document read instruction from the control unit 18. More specifically, the scanner unit 12 forms the reflected light obtained by exposing/scanning the image on a document into an image on a CCD. The scanner unit 12 then converts the resultant image information into an RGB electrical signal and outputs it to the control unit 18.

The printer unit 14 forms an image corresponding to the image data input from the control unit 18 on a printing sheet.

The operation unit 16 includes, for example, a touch panel. The operation unit 16 displays an image (e.g., information concerning the state of the image forming apparatus 10) corresponding to the image data input from the control unit 18, and also outputs information to the control unit 18 upon receiving operation (instruction) from the user.

The control unit 18 is electrically connected to the scanner unit 12, the printer unit 14, the operation unit 16, and the like. The control unit 18 can communicate (i.e., can transmit and receive image data and device information) with the host computer 60, an external apparatus, or the like via the network 80.

As shown in FIG. 2, the control unit 18 includes a CPU 201, a RAM 202, a ROM 203, an operation unit interface (I/F) 204, and a network interface (I/F) 205. The control unit 18 also includes a hard disk 206, a hard disk controller 207, a system bus 208, an image bus 209, a scanner image processing unit 210, a scanner interface (I/F) 211, a compression unit 212, and a decompression unit 213. The control unit 18 further includes a printer image processing unit 214, a printer interface (I/F) 215, a RIP (Raster Image Processor) 216, a compression unit 217, an image conversion unit 218, and a power supply unit 219.

The CPU 201 comprehensively controls access to various types of devices and various types of processing executed inside the apparatus based on programs stored in the ROM 203. The RAM 202 functions as a system work memory for the operation of the CPU 201. The RAM 202 also functions as a memory for temporarily storing (saving) image data. The RAM 202 includes an SRAM which holds its contents (e.g., image data) even after the power is turned off and a DRAM which erases its contents after the power is turned off. The ROM 203 stores a boot program for the image forming apparatus 10.

The operation unit I/F 204 is an interface for connecting the operation unit 16 to the system bus 208. The operation unit I/F 204 receives image data corresponding to an image to be displayed on the operation unit 16 from the system bus 208 and outputs the data to the operation unit 16. The operation unit I/F 204 also outputs the user instruction input from the operation unit 16 to the system bus 208.

The network I/F 205 is an interface for connecting the network 80 to the system bus 208. The network I/F 205 inputs/outputs information (data) from/to the apparatuses connected to the network 80.

The hard disk controller 207 controls the hard disk 206 to store (save) system software and image data. The hard disk 206 contains a storage area (storage box) used as part of one virtual storage area (big box) in the image forming system 1.

In this embodiment, the image bus 209 includes a PCI bus, which is a transmission path for the transmission/reception of image data.

The scanner image processing unit 210 receives image data from the scanner unit 12 via the scanner I/F 211. The scanner image processing unit 210 then corrects, processes, and edits the image data. Note that the scanner image processing unit 210 discriminates whether the image data received from the scanner unit 12 is color image data, monochrome image data, character data, or photographic data, and adds the discrimination result as additional information (image area data) to the image data.

The compression unit 212 generates a plurality of image data (tile data) by dividing the image data from the scanner image processing unit 210 into blocks each including 32 pixels×32 pixels, and compresses the plurality of image data. The image data compressed by the compression unit 212 is sent to and stored (saved) in the RAM 202. Note that the image data stored in the RAM 202 is sent to and processed by the image conversion unit 218, as needed. The resultant data is sent again to and stored in the RAM 202.

The image data read out from the RAM 202 is attached with a file name in accordance with the setting made by the user, and is stored (saved) in a predetermined directory in the hard disk 206. The image data read out from the hard disk 206 is output to the system bus 208 to, for example, be sent to the operation unit 16 for image display or sent to a predetermined destination in accordance with the setting made by the user. When, for example, the printer unit 14 is to form an image, the image data read out from the hard disk 206 is sent to the decompression unit 213 via the system bus 208.

The decompression unit 213 decompresses image data, and rasterizes the image data formed of a plurality of tile data after decompression. The decompression unit 213 sends the rasterized image data to the printer image processing unit 214.

The printer image processing unit 214 performs predetermined image processing for the image data from the decompression unit 213, and sends the image data to the printer unit 14 via the printer I/F 215. The printer unit 14 forms an image corresponding to the image data from the printer image processing unit 214 on a printing sheet, as described above.

The RAM 202 also stores (saves), via the network I/F 205, the PDL data sent from the host computer 60 via the network 80. The CPU 201 analyzes the PDL data and sends the intermediate data generated by the analysis to the RIP 216.

The RIP 216 generates image data in the raster format by rendering the intermediate data from the CPU 201, and sends the image data to the compression unit 217.

The compression unit 217 divides the image data into blocks and compresses them. The compression unit 217 sends the compressed image data to the RAM 202. As described above, the image data stored in the RAM 202 is output to the system bus 208 via the hard disk 206, and is sent to the printer unit 14 via the decompression unit 213, the printer image processing unit 214, and the printer I/F 215.

The power supply unit 219 controls power supply in the image forming apparatus 10. For example, the power supply unit 219 turns on/off the supply of the power supplied from an external power supply to the respective units (the scanner unit 12, printer unit 14, and control unit 18).

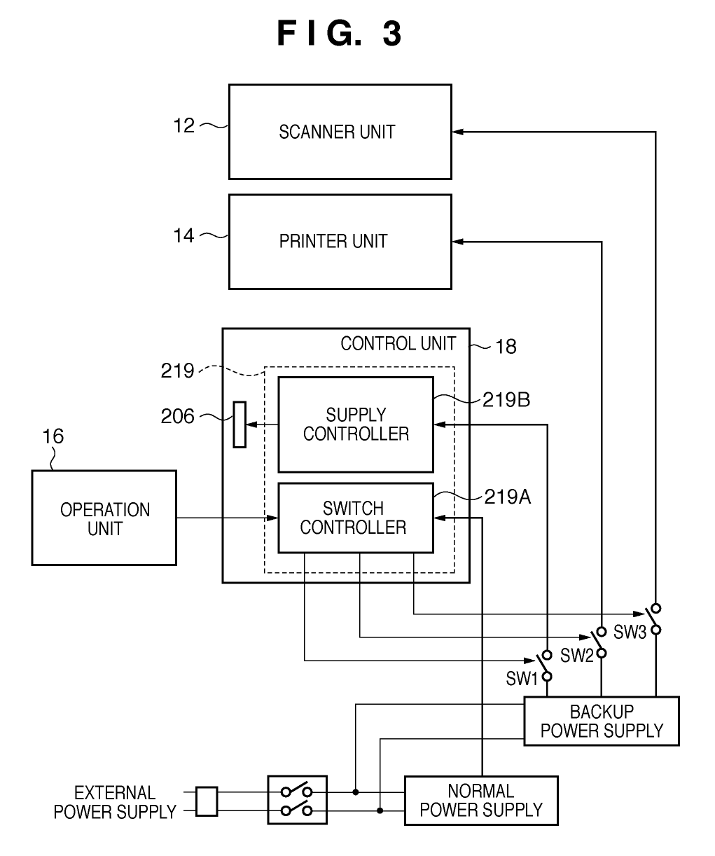

FIG. 3 is a view for explaining control of power supply by the power supply unit 219. The power supply unit 219 includes a switch controller 219A and a supply controller 219B. The switch controller 219A controls power supply to the supply controller 219B, the printer unit 14, and the scanner unit 12 via switches SW1, SW2, and SW3. The supply controller 219B distributes the power supplied from the external power supply to the respective units (the hard disk 206 and the like) constituting the control unit 18.

More specifically, when the operation unit 16 issues an instruction to make transition from the normal state to the power saving state or power off state, the switch controller 219A turns off all the switches SW1, SW2, and SW3. This turns off power supply to the supply controller 219B, the printer unit 14, and the scanner unit 12. When power supply to the supply controller 219B is turned off, no power is supplied to the hard disk 206. This makes it impossible for other apparatuses to access the hard disk 206.

In contrast, when the operation unit 16 issues an instruction to make transition from the power saving state or power off state to the normal state, the switch controller 219A turns on all the switches SW1, SW2, and SW3. This turns on power supply to the supply controller 219B, the printer unit 14, and the scanner unit 12. When power supply to the supply controller 219B is turned on, power is supplied to the hard disk 206 via the supply controller 219B. This makes it possible for other apparatuses to access the hard disk 206.

Note that in this embodiment, the switch controller 219A turns on or off all the switches SW1, SW2, and SW3 to make transition from the normal state to the power saving state or power off state or transition from the power saving state or power off state to the normal state. Obviously, however, it is possible to make transition of the image forming apparatus 10 to various states by causing the switch controller 219A to independently turn on or off the switches SW1, SW2, and SW3.

Referring back to FIG. 1, the host computer 60 includes a general-purpose computer. The host computer 60 can transmit/receive files (data) and electronic mail via the network 80 by using FTP (File Transfer Protocol) and SMB (Server Message Block) protocol. In addition, the host computer 60 can issue print instructions to the image forming apparatuses 10 to 50 connected to the network 80 via a printer driver.

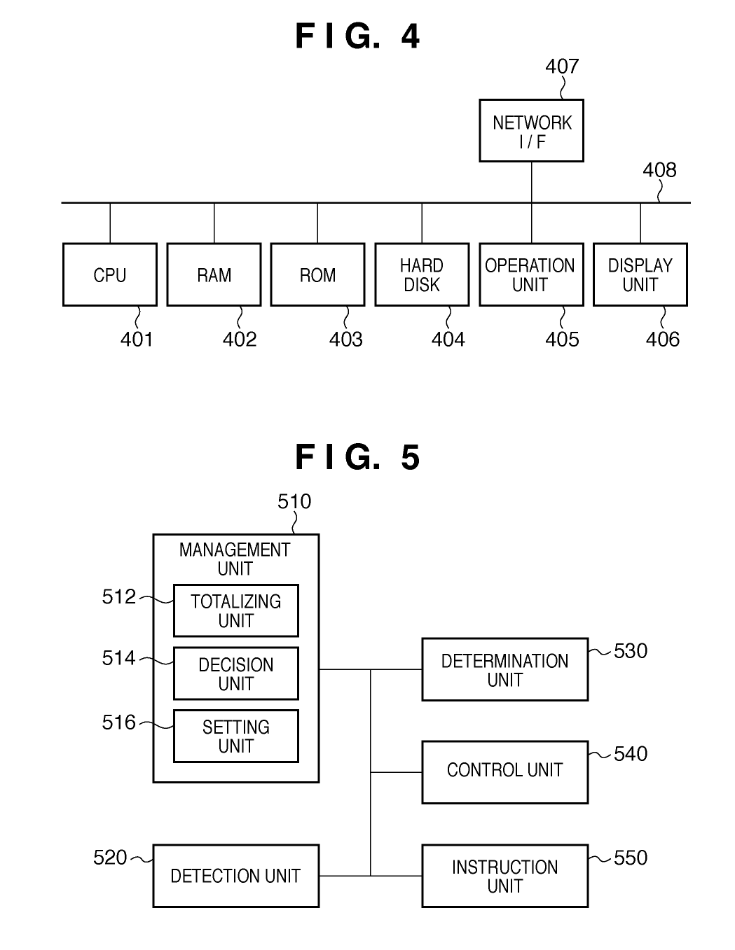

The management apparatus 70 has a function of managing the image forming apparatuses 10 to 50 connected to the network 80, and includes a general-purpose computer. As shown in FIG. 4, the management apparatus 70 includes a CPU 401, a RAM 402, a ROM 403, a hard disk 404, an operation unit 405, a display unit 406, a network interface (I/F) 407, and a system bus 408. FIG. 4 is a schematic block diagram showing an example of the arrangement of the management apparatus 70.

The CPU 401 comprehensively controls access to various types of devices and various types of processing inside the apparatus based on programs stored in the ROM 403. Note that the CPU 401 executes programs stored in a computer-readable recording medium such as the ROM 403 to implement management (to be described later) of the image forming apparatuses 10 to 50. The RAM 402 functions as a system work memory for the operation of the CPU 401. The ROM 403 stores a boot program for the management apparatus 70. The hard disk 404 stores programs and data associated with various types of processing and information concerning the image forming apparatuses 10 to 50 to be managed. The operation unit 405 includes a keyboard, pointing device, and the like, which accept instructions to the management apparatus 70. The display unit 406 displays the operation state of the management apparatus 70 and the information output from various types of programs operating on the management apparatus 70. The network I/F 407 is an interface for connecting the network 80 to the management apparatus 70. The system bus 408 connects the CPU 401, the RAM 402, the ROM 403, the hard disk 404, the operation unit 405, the display unit 406, and the network I/F 407.

In the management apparatus 70, the components ranging from the CPU 401 to the system bus 408 implement a management unit 510, a detection unit 520, a determination unit 530, a control unit 540, and an instruction unit 550 shown in FIG. 5 independently or in cooperation. FIG. 5 is a block diagram showing the function arrangement implemented by the management apparatus 70.

The management unit 510 includes a totalizing unit 512, a decision unit 514, and a setting unit 516. The management unit 510 forms and manages one virtual storage area (big box) in the network 80. More specifically, the management unit 510 forms a big box which can be handled as one storage area in the overall image forming system 1 from the storage areas (partial storage areas in the hard disks) which can be respectively provided by the image forming apparatuses 10 to 50 connected to the network 80.

A totalizing unit 512 obtains a first capacity by totalizing the capacities of storage areas that can be provided as a big box by the image forming apparatuses 10 to 50.

The decision unit 514 decides, as the capacity of the big box, the second capacity smaller than the first capacity obtained by the totalizing unit 512.

The setting unit 516 divides the storage area that can be provided as part of a big box by each of the image forming apparatuses 10 to 50 into a use area and a preliminary area, and sets, as the second capacity, the sum total of the capacities of the use areas in the image forming apparatuses 10 to 50. In this case, a use area is an area that is used as part of the big box when all the image forming apparatuses 10 to 50 are connected to the network 80 (i.e., the state in which the respective apparatuses are not in the power saving state or power off state and can access each other). A preliminary area is an area that can be used as part of the big box when at least one of the image forming apparatuses 10 to 50 is disconnected from the network 80 (in the power saving state, the power off state, or the like which does not allow access from other apparatuses).

The detection unit 520 detects a request to disconnect from the network 80 (i.e., a request to make transition to the power saving state or power off state) from at least one of the image forming apparatuses 10 to 50. Note that when a given image forming apparatus makes transition to the power saving state or power off state, the management apparatus 70 cannot access any data stored in the image forming apparatus. A request to disconnect is therefore a request (stop request) transmitted to the management apparatus 70 to stop providing any storage area managed by the management apparatus 70 as a virtual storage area.

When the detection unit 520 detects a request to disconnect from the network 80, the determination unit 530 determines whether the storage area used as part of a big box by the image forming apparatus that has issued the request to disconnect can be allocated to the storage area that can be provided by another image forming apparatus. More specifically, if the capacity of the storage area used as part of a big box in the image forming apparatus which has issued the request to disconnect from the network 80 is equal to or less than the capacity of the preliminary area in another image forming apparatus, the determination unit 530 determines that the storage area can be allocated. If the capacity of the storage area used as part of a big box in the image forming apparatus that has issued the request to disconnect from the network 80 is larger than the capacity of the preliminary area in another image forming apparatus, the determination unit 530 determines that the storage area cannot be allocated.

The control unit 540 controls the connection of each of the image forming apparatuses 10 to 50 to the network 80 based on the determination result obtained by the determination unit 530. More specifically, if the determination unit 530 determines that the storage area can be allocated to the storage area that can be provided by another image forming apparatus, the control unit 540 permits the image forming apparatus that has issued the request to disconnect to disconnect from the network 80. If the determination unit 530 determines that the storage area cannot be allocated to the storage area that can be provided by another image forming apparatus, the control unit 540 prohibits the image forming apparatus that has issued the request to disconnect from disconnecting from the network 80.

The instruction unit 550 issues an instruction to transfer the data stored in the storage area used as part of the big box by the image forming apparatus that has issued the request to disconnect to the preliminary area in another image forming apparatus. Obviously, the instruction unit 550 issues such an instruction only when the determination unit 530 determines that the storage area can be allocated to the storage area which can be provided by another image forming apparatus, and the control unit 540 permits disconnection from the network 80 upon the completion of transfer of the data.

The following is a concrete description of management of the image forming apparatuses 10 to 50 by the management apparatus 70 (control of the formation of a big box in the image forming system 1 and the connection of each of the image forming apparatuses 10 to 50 to the network 80).

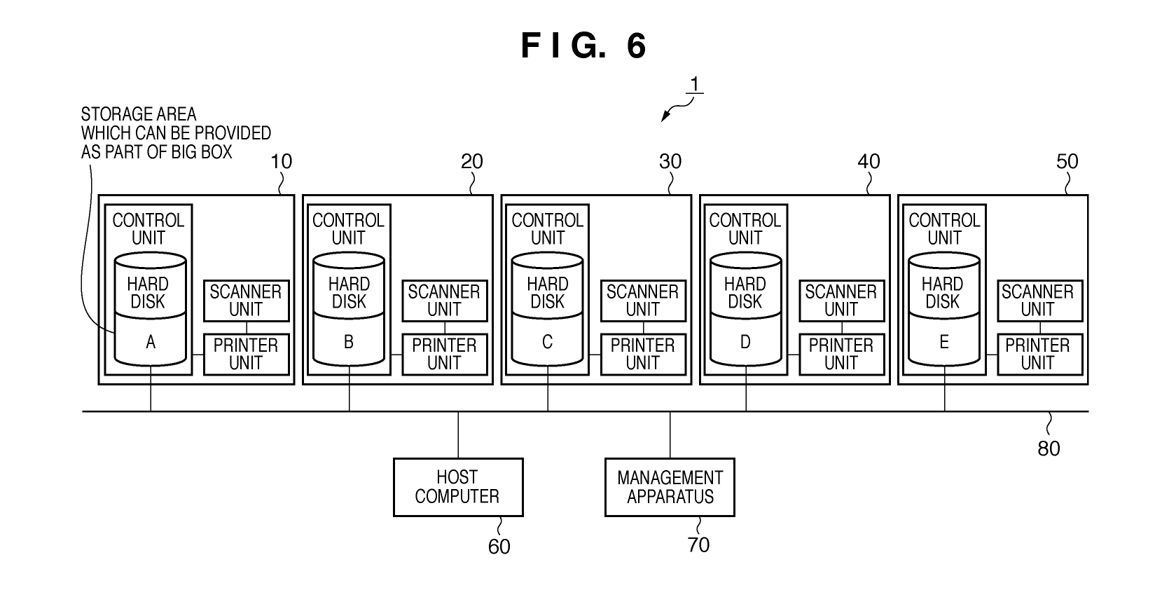

Assume that in this embodiment, each of the image forming apparatuses 10 to 50 can provide part of the storage area of the hard disk, i.e., each of the storage areas A to E, as part of the big box, as shown in FIG. 6. FIG. 6 is a view showing the storage areas A to E each of which can be provided as part of the big box in a corresponding one of the hard disks of the image forming apparatuses 10 to 50.

The management apparatus 70 (totalizing unit 512) totalizes the capacities of the storage areas A to E which can be respectively provided by the image forming apparatuses 10 to 50 connected to the network 80. The management apparatus 70 (decision unit 514) then decides the capacity of the big box in this embodiment such that the capacity (second capacity) becomes smaller than the totalized capacity (first capacity).

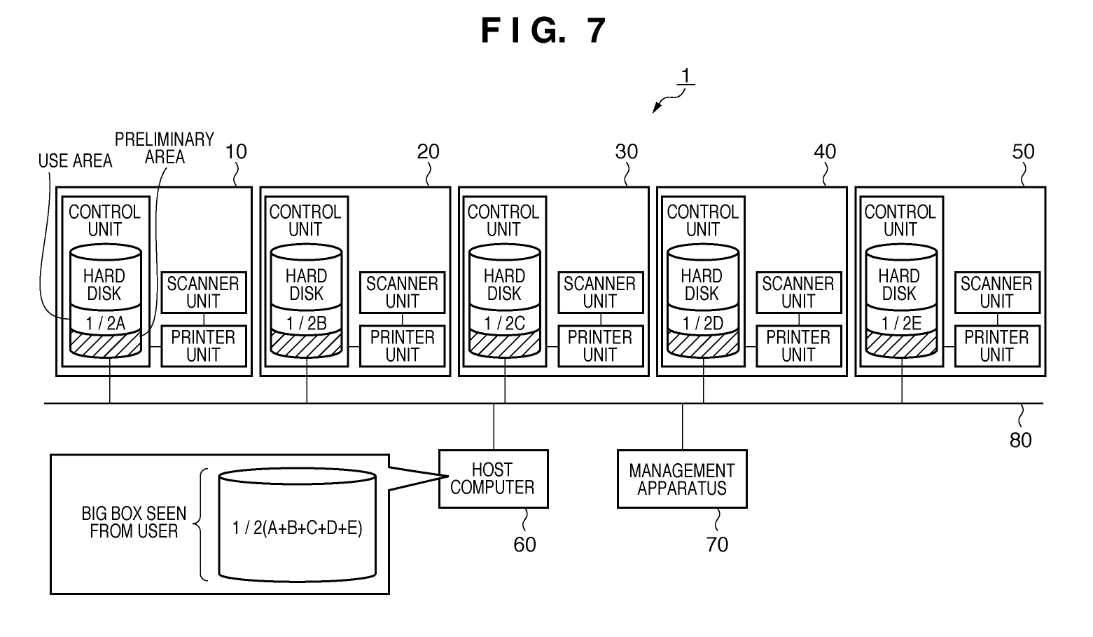

As shown in FIG. 7, in each of the image forming apparatuses 10 to 50, the management apparatus (setting unit 516) allocates and sets ½ each of the storage areas A to E, which can be provided as part of the big box, as a use area, and the remaining area (½ each of the storage areas A to E) as a preliminary area. In this case, the sum total of the capacities of the use areas in the image forming apparatuses 10 to 50 is the decided capacity of the big box. This makes the host computer 60 connected to the network 80 or each of the image forming apparatuses 10 to 50 (user) see as if a big box having a capacity (storage area) of ½ (A+B+C+D+E) were formed. Note that the management apparatus 70 may automatically decide or the user may arbitrarily decide the ratio between a use area and a preliminary area. FIG. 7 is a view showing an example of the big box formed from the storage areas A to E that can respectively be provided by the image forming apparatuses 10 to 50.

Assume that the management apparatus 70 (detection unit 520) has detected a request to disconnect from the network 80 from the image forming apparatus 30. In this case, the management apparatus (determination unit 530) determines whether the storage area (½C) used as part of the big box in the image forming apparatus 30 can be allocated to the storage area (in particular, the preliminary area) which can be provided by each of the image forming apparatuses 10, 20, 40, and 50. In this case, since the capacity of the storage area (½C) used as part of the big box in the image forming apparatus 30 is equal to or less than the capacity of the preliminary area of each of the image forming apparatuses 10, 20, 40, and 50, the management apparatus 70 (determination unit 530) determines that the storage area can be allocated.

The management apparatus 70 (instruction unit 550) instructs the image forming apparatus 30 to transfer the data stored in its storage area (½C) used as part of the big box to, for example, the preliminary area in the image forming apparatus 40. The management apparatus 70 (control unit 540) also permits the image forming apparatus 30 to disconnect from the network 80.

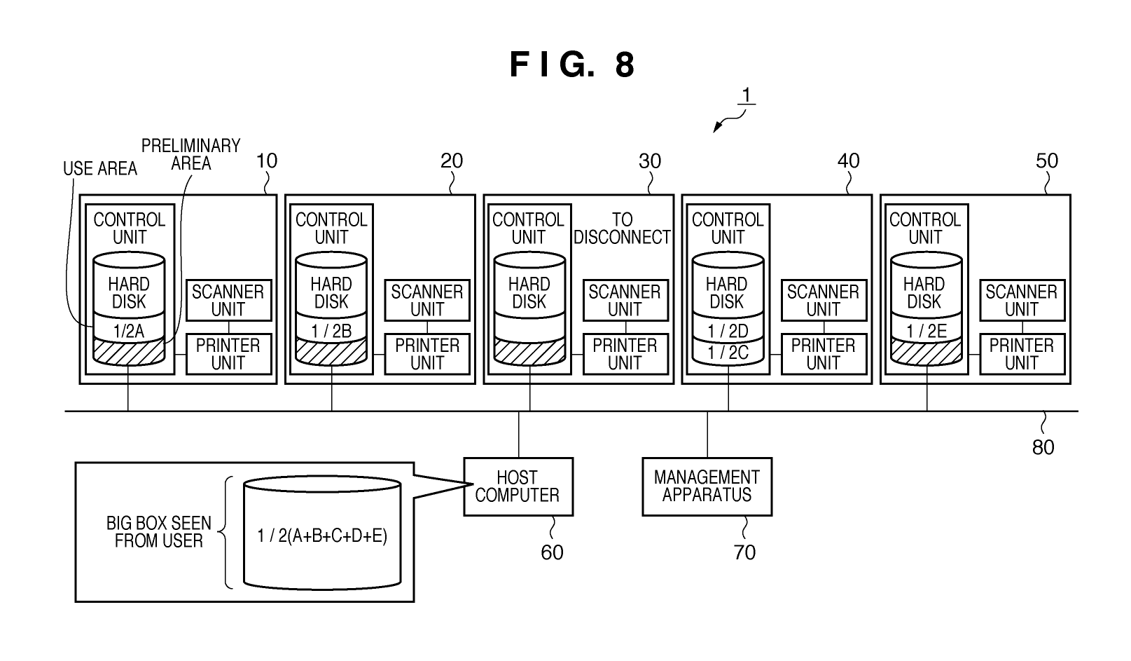

FIG. 8 is a view showing a state in which the image forming apparatus 30 of the image forming apparatuses 10 to 50 is disconnected from the network 80. Referring to FIG. 8, the storage area (½C) used as part of the big box in the image forming apparatus 30 is allocated to the preliminary area in the image forming apparatus 40. This embodiment, therefore, can disconnect the image forming apparatus 30 from the network 80 (set the apparatus in the power saving state or power off state) while maintaining the function (capacity) of the big box before and after disconnecting the image forming apparatus 30 from the network 80.

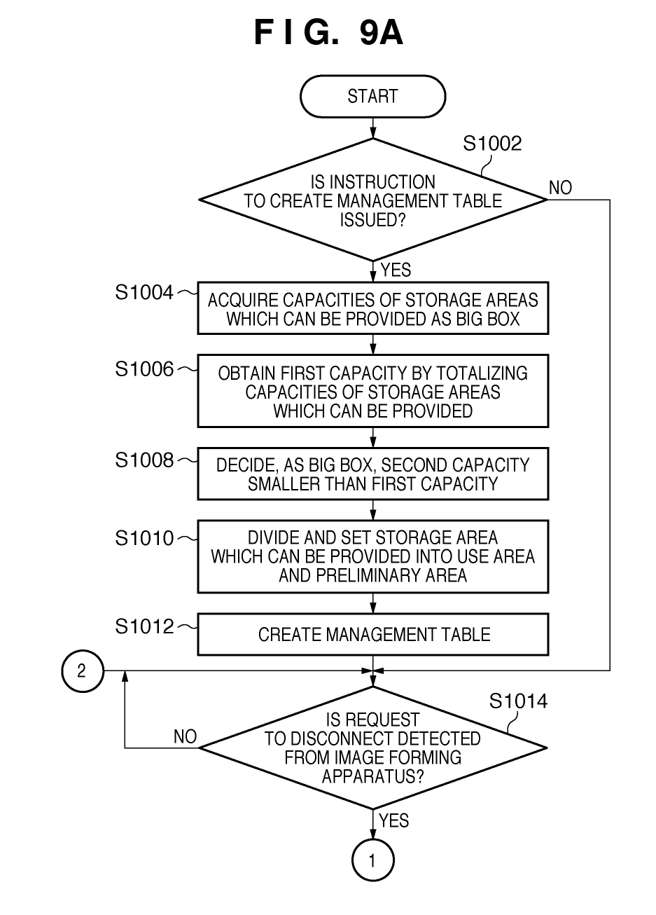

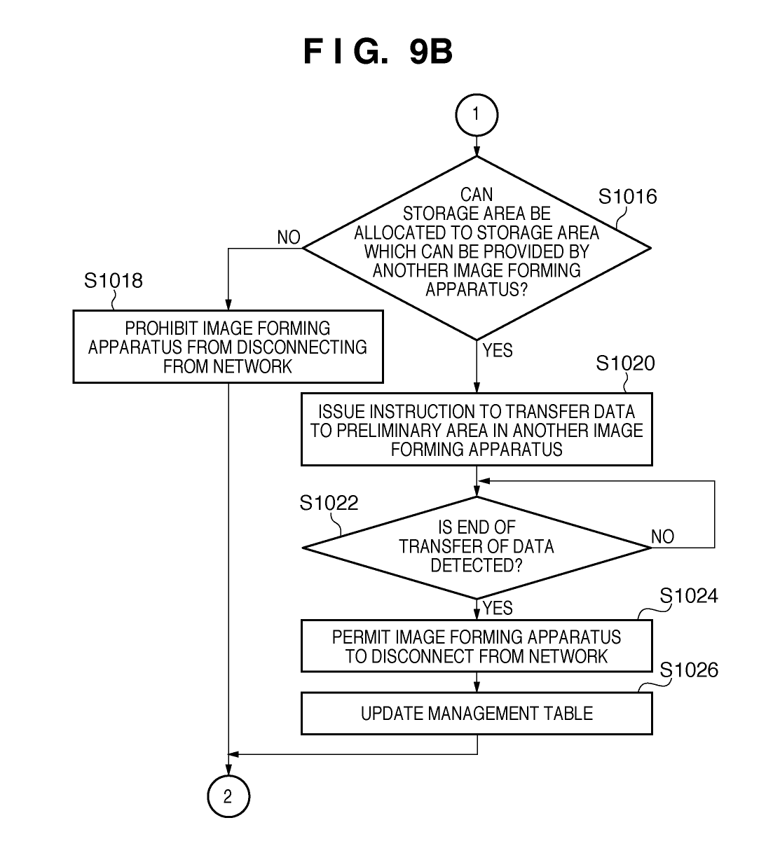

Processing in the management apparatus 70 that is associated with management of the image forming apparatuses 10 to 50 will be described with reference to FIGS. 9A and 9B. Note that management of the image forming apparatuses 10 to 50 is control of the formation of a big box in the image forming system 1 and the connection of each of the image forming apparatuses 10 to 50 to the network 80 as described above.

In step S1002, the management apparatus 70 determines whether an instruction to create a management table is issued. A management table is a table for maintaining the function of the big box in the image forming system 1. This table indicates the relationship between the storage area in each of the image forming apparatuses 10 to 50 and the big box. When, therefore, the image forming system 1 is constructed for the first time or an image forming apparatus is added or removed, the user issues an instruction to create a management table.

If the management apparatus 70 determines that no instruction to create a management table has been issued, the process advances to step S1014. If the management apparatus 70 determines that an instruction to create a management table has been issued, the process advances to step S1004.

In step S1004, the management apparatus 70 acquires the capacity of the storage area that can be provided as part of a big box by each of the image forming apparatuses 10 to 50 connected to the network 80. Note that it is possible to acquire the capacities of the storage areas which can be respectively provided by the image forming apparatuses 10 to 50 by inquiring the image forming apparatuses 10 to 50.

In step S1006, the management apparatus 70 obtains the first capacity by totalizing the capacities of the storage areas which can be respectively provided by the image forming apparatuses 10 to 50 and are obtained in step S1004.

In step S1008, the management apparatus 70 decides, as the capacity of the big box, the second capacity smaller than the first capacity obtained in step S1006. Note that it is possible to decide the second capacity as the capacity of the big box in accordance with an instruction from the user or a predetermined ratio (for example, ½ the first capacity).

In step S1010, the management apparatus 70 divides the storage area that can be provided, as part of the big box, by each of the image forming apparatuses 10 to 50 into parts and sets them as a use area and a preliminary area. In this case, the management apparatus 70 sets the sum total of the capacities of the use areas in the image forming apparatuses 10 to 50 equal to the capacity (second capacity) of the big box decided in step S1008. This will form one big box on the network 80 from the storage areas which can be respectively provided by the image forming apparatuses 10 to 50.

In step S1012, the management apparatus 70 creates a management table based on the processing in steps S1004 to S1010.

In step S1014, the management apparatus 70 detects, from at least one of the image forming apparatuses 10 to 50, a request to disconnect from the network 80 (a request to make transition to the power saving state or power off state). When the management apparatus 70 detects, from at least one of the image forming apparatuses 10 to 50, a request to disconnect from the network 80, the process advances to step S1016.

In step S1016, the management apparatus 70 determines whether the storage area used as part of the big box in the image forming apparatus which has issued the request to disconnect can be allocated to the storage area which can be provided by another image forming apparatus.

If the management apparatus 70 determines that the storage area used as part of the big box in the image forming apparatus which has issued the request to disconnect cannot be allocated to the storage area which can be provided by another image forming apparatus, the process advances to step S1018.

In step S1018, the management apparatus 70 prohibits the image forming apparatus which has issued the request to disconnect from disconnecting from the network 80. The process then returns to step S1014.

In contrast, if the management apparatus 70 determines that the storage area used as part of the big box in the image forming apparatus which has issued the request to disconnect can be allocated to the storage area which can be provided by another image forming apparatus, the process advances to step S1020.

In step S1020, the management apparatus 70 instructs the image forming apparatus that has issued the request to disconnect to transfer the data stored in its storage area used as part of the big box to the preliminary area in another image forming apparatus.

In step S1022, the management apparatus 70 detects the end of transfer of the data stored in the storage area used as part of the big box in the image forming apparatus that has issued the request to disconnect.

When the management apparatus 70 detects the end of transfer of the data stored in the storage area used as part of the big box in the image forming apparatus which has issued the request to disconnect, the process advances to step S1024.

In step S1024, the management apparatus 70 permits the image forming apparatus which has issued the request to disconnect to disconnect from the network 80.

In step S1026, the management apparatus 70 updates the management table by reflecting the ratio between the use area and the preliminary area in each of the image forming apparatuses 10 to 50 which has been changed by the processing in steps S1014, S1016, S1020, S1022, and S1024. The process returns to step S1014.

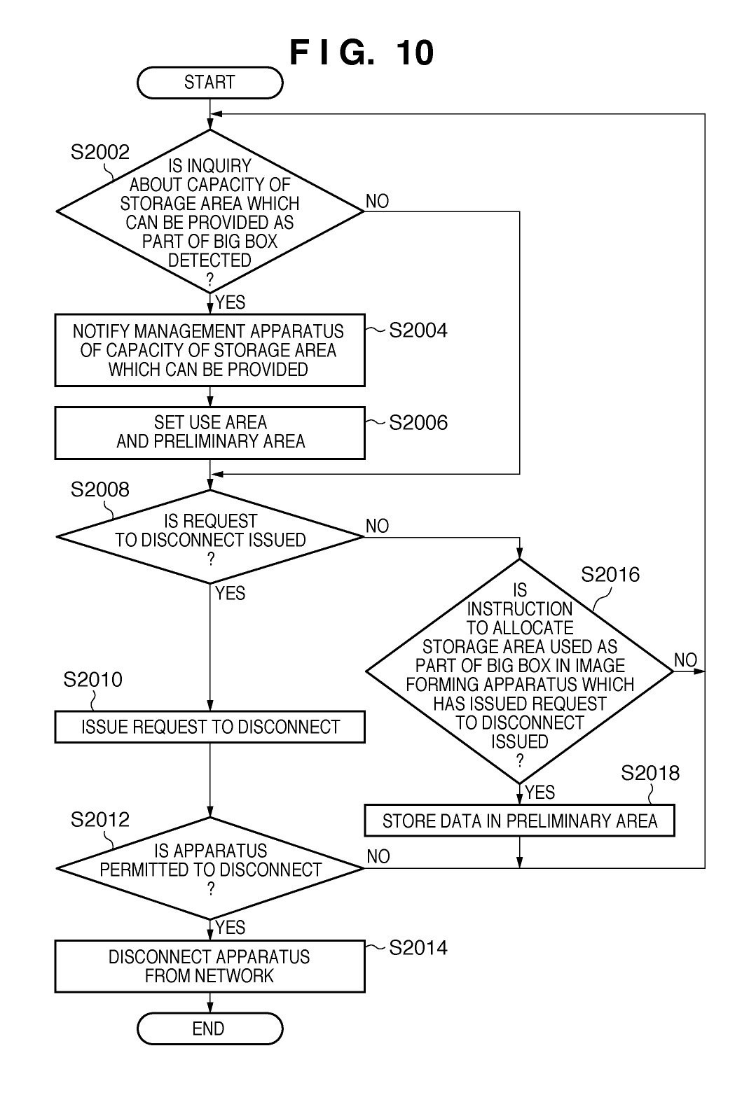

Processing in the image forming apparatuses 10 to 50 which corresponds to the processing in the management apparatus 70 which is shown in FIGS. 9A and 9B will be described with reference to FIG. 10.

In step S2002, each image forming apparatus detects, from the management apparatus 70, an inquiry about the capacity of the storage area which can be provided as part of the big box.

If the image forming apparatus detects an inquiry about the capacity of the storage area which can be provided as part of the big box, the process advances to step S2004. In step S2004, the image forming apparatus notifies the management apparatus 70 of the capacity of the storage area which can be provided as part of the big box.

If the image forming apparatus has detected no inquiry about the capacity of the storage area which can be provided as part of the big box, the process advances to step S2008. In step S2006, the image forming apparatus sets a use area and a preliminary area in the storage area which can be provided as part of the big box in accordance with an instruction from the management apparatus 70.

In step S2008, the image forming apparatus determines whether a request to disconnect from the network 80 (a request to make transition to the power saving state or power off state) has been issued. The user operates the operation unit 16 to issue a request to disconnect. Alternatively, such a request is automatically issued when the image forming apparatus has not been used for a predetermined period of time.

If the image forming apparatus determines that a request to disconnect has been issued, the process advances to step S2010. In step S2010, the image forming apparatus issues a request to disconnect from the network 80 to the management apparatus 70.

If the image forming apparatus determines that no request to disconnect has been issued, the process advances to step S2016. In step S2012, the image forming apparatus determines whether the management apparatus 70 has permitted disconnection from the network 80.

If the image forming apparatus determines that disconnection is permitted, the process advances to step S2014. If the image forming apparatus determines that disconnection is not permitted (is prohibited), the process returns to step S2002.

In step S2014, the image forming apparatus disconnects from the network 80 (makes transition to the power saving state or power off state), and terminates the processing.

In step S2016, the image forming apparatus determines whether the management apparatus 70 has issued an instruction to allocate the storage area used as part of the big box in the image forming apparatus that has issued a request to disconnect.

If the image forming apparatus determines that the management apparatus 70 has issued an instruction to allocate the storage area used as part of the big box in the image forming apparatus which has issued the request to disconnect, the process advances to step S2018. If the image forming apparatus determines that the management apparatus 70 has issued no instruction to allocate the storage area used as part of the big box in the image forming apparatus that has issued the request to disconnect, the process returns to step S2002.

In step S2018, the data transferred from the image forming apparatus that has issued the request to disconnect is stored (saved) in the preliminary area. The process then returns to step S2002.

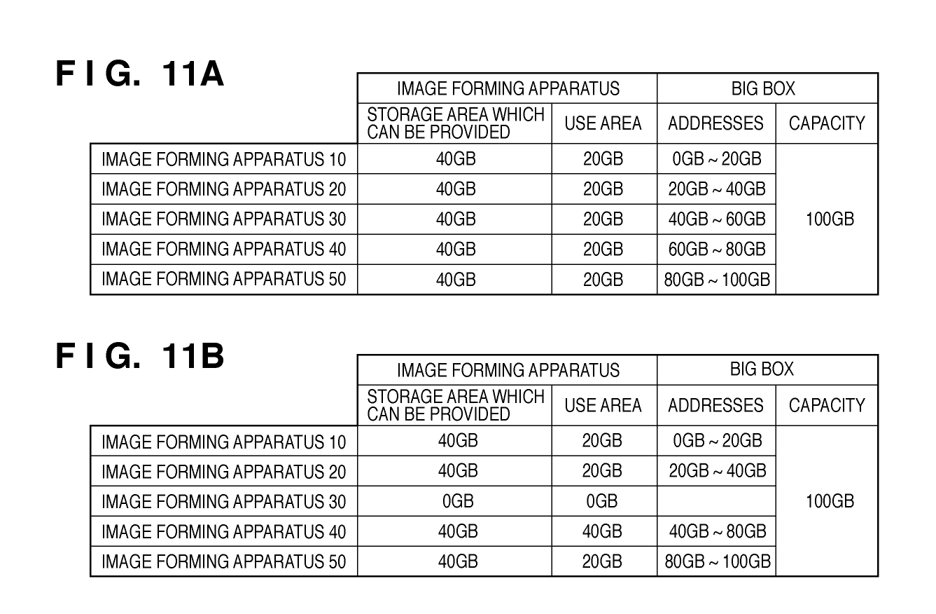

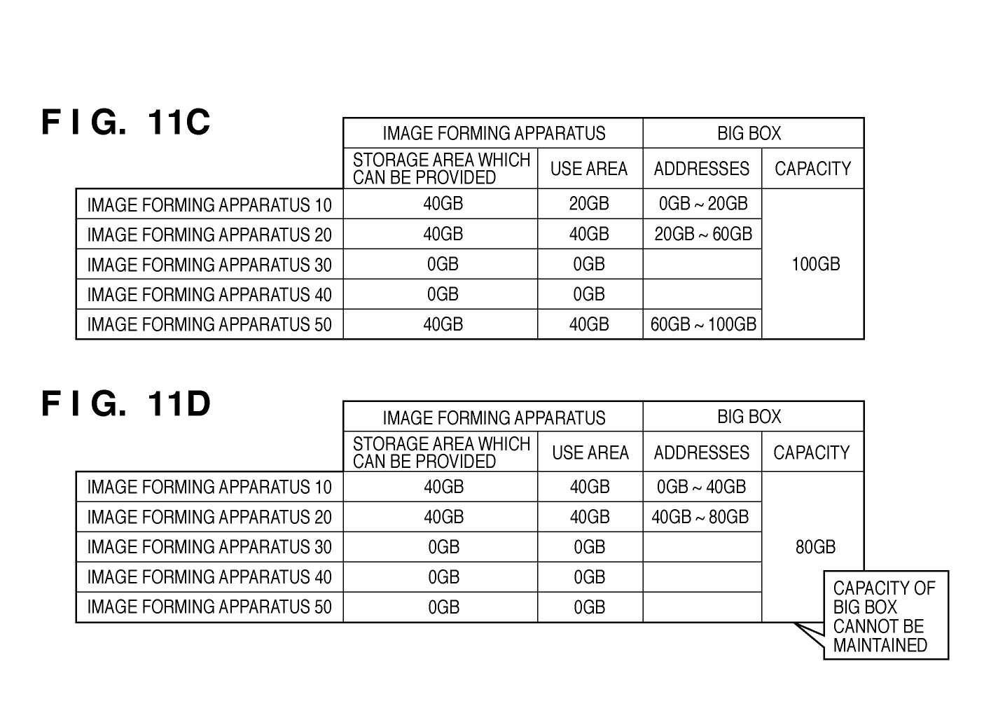

FIGS. 11A to 11D are views each showing an example of a management table which is created and updated by the management apparatus 70. The management table shown in each of FIGS. 11A to 11D indicates the storage area (capacity) which can be provided as part of a big box, a use area (capacity), the addresses in the big box, and the capacity of the big box in each of the image forming apparatuses 10 to 50.

FIG. 11A shows the management table created first. Referring to FIG. 11A, since the storage area which can be provided by each of the image forming apparatuses 10 to 50 is 40 GB, it is possible to form a big box having a capacity of 200 GB. In this embodiment, however, the capacity of the big box is set to 100 GB, and the use area in each of the image forming apparatuses 10 to 50 is set to 20 GB. Note that each remaining storage area (20 GB) is set as a preliminary area.

FIG. 11B shows the management table updated when the image forming apparatus 30 is disconnected from the network 80. Referring to FIG. 11B, the storage area (20 GB) used as part of the big box in the image forming apparatus 30 is allocated to the preliminary area (20 GB) in the image forming apparatus 40. Obviously, therefore, the capacity of the big box is maintained at 100 GB.

FIG. 11C shows the management table updated when the image forming apparatus 40 is disconnected from the network 80, in addition to the image forming apparatus 30. Referring to FIG. 11C, the storage area (40 GB) used as part of the big box in the image forming apparatus 40 is allocated to the preliminary area (20 GB) in the image forming apparatus 20 and the preliminary area (20 GB) in the image forming apparatus 50. Obviously, therefore, the capacity of the big box is maintained at 100 GB.

FIG. 11D shows the management table in a case in which the image forming apparatus 50 is disconnected from the network 80, in addition to the image forming apparatuses 30 and 40. Referring to FIG. 11D, only part (20 GB) of the storage area (40 GB) used as part of the big box in the image forming apparatus 50 can be allocated to the preliminary area (20 GB) in the image forming apparatus 10. Therefore, the capacity of the big box becomes 80 GB. That is, a capacity of 100 GB cannot be maintained. In such a case, as described above, the management apparatus 70 prohibits the image forming apparatus 50 from disconnecting from the network 80. In practice, therefore, the management table shown in FIG. 11D is not updated.

As described above, this embodiment can control the connection of each image forming apparatus to a network so as to maintain the function (capacity) of the big box formed by a plurality of image forming apparatuses. In other words, the embodiment allows each image forming apparatus (its storage apparatus) to be disconnected from the network (be set in the power saving state or power off state) within the range in which the function of the big box is maintained.

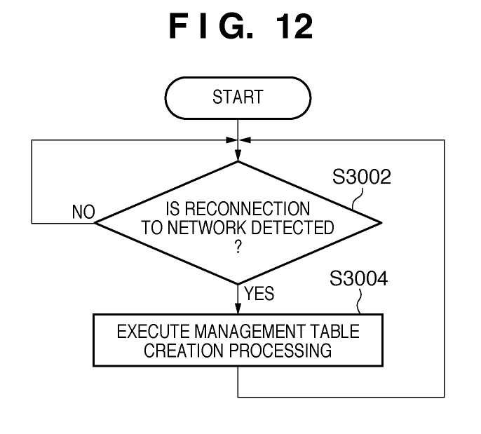

Note that the management apparatus 70 also manages (monitors) the restoration (i.e., transition from the power saving state or power off state to the normal state) of each image forming apparatus (its storage apparatus) which is disconnected from the network 80. FIG. 12 is a flowchart for explaining processing in the management apparatus 70 which is associated with the restoration of each image forming apparatus that is disconnected from the network 80.

In step S3002, the management apparatus 70 detects that an image forming apparatus disconnected from the network 80 is reconnected to the network 80.

When the management apparatus 70 detects that an image forming apparatus disconnected from the network 80 is reconnected to the network 80, the process advances to step S3004.

In step S3004, the management apparatus 70 executes management table creation processing. Note that management table creation processing is the same as the processing in steps S1004 to S1012 shown in FIGS. 9A and 9B, and hence a detailed description of the processing will be omitted.

In addition, the management apparatus 70 may group the image forming apparatuses 10 to 50 in accordance with the capacities of the storage areas which can be provided as a big box, and may control the connection of image forming apparatuses in each group to the network 80.

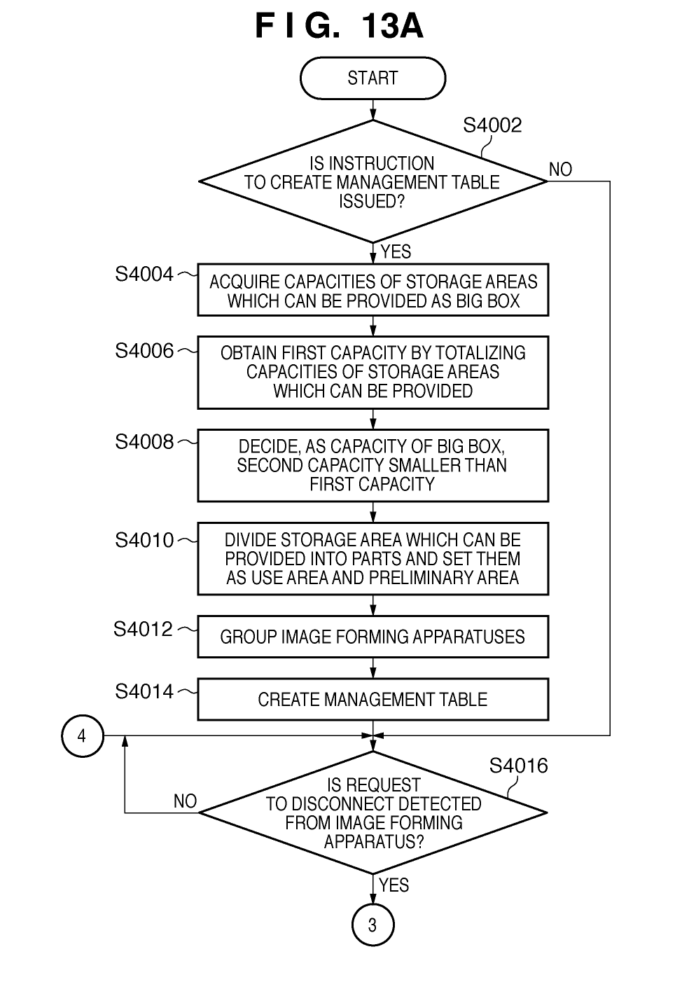

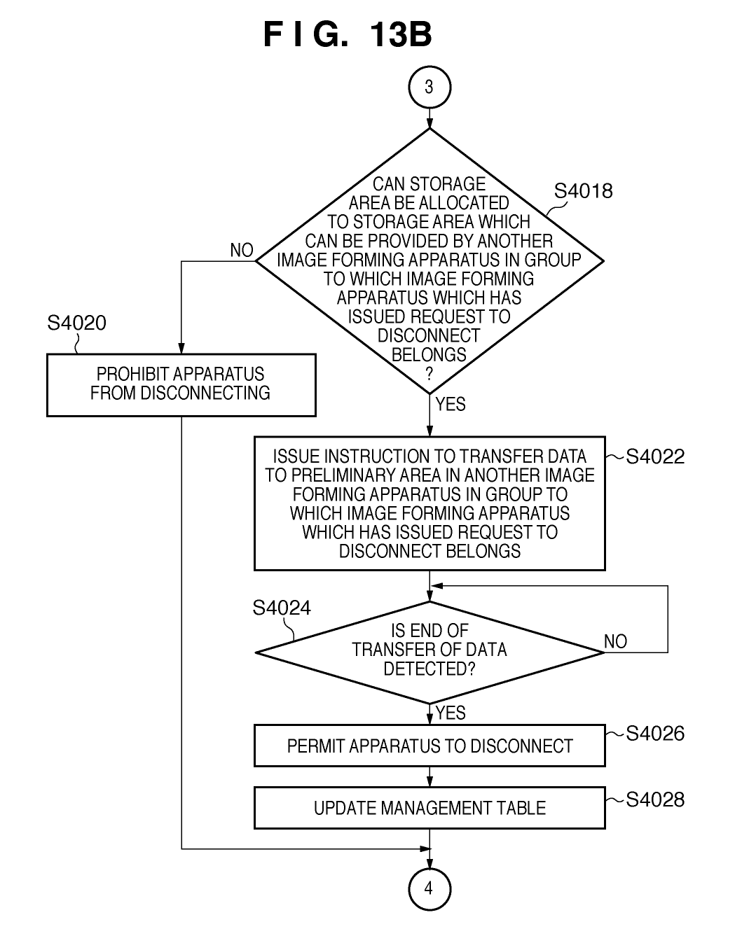

FIGS. 13A and 13B are flowcharts for explaining the processing to be performed by the management apparatus 70 when the image forming apparatuses 10 to 50 are grouped in accordance with the capacities of the storage areas which can be provided as a big box. Since processing in steps S4002 to S4010 is the same as the processing in steps S1002 to S1010 shown in FIG. 9A, a detailed description of the processing will be omitted.

In step S4012, the management apparatus 70 groups the image forming apparatuses 10 to 50 in accordance with the capacities of the storage areas which can be respectively provided by the image forming apparatuses 10 to 50 which are acquired in step S4004. This embodiment divides the image forming apparatuses 10 to 50 into groups each including image forming apparatuses whose storage areas which can be provided as the big box have the same or similar capacities.

In step S4014, the management apparatus 70 creates a management table based on the processing in steps S4004 to S4012. Such a management table contains information indicating to which groups each of the image forming apparatuses 10 to 50 belongs.

In step S4016, the management apparatus 70 detects, from at least one of the image forming apparatuses 10 to 50, a request to disconnect from the network 80 (to make transition to the power saving state or power off state). If the management apparatus 70 detects, from at least one of the image forming apparatuses 10 to 50, a request to disconnect from the network 80, the process advances to step S4018.

In step S4018, the management apparatus 70 determines whether the storage area used as part of the big box in the image forming apparatus that has issued the request to disconnect can be allocated to the storage area that can be provided by another image forming apparatus in the group to which the above image forming apparatus belongs.

If the management apparatus 70 determines that the storage area used as part of the big box in the image forming apparatus which has issued the request to disconnect cannot be allocated to the storage area which can be provided by another image forming apparatus in the group to which the above image forming apparatus belongs, the process advances to step S4020.

In step S4020, the management apparatus 70 prohibits the image forming apparatus that has issued the request to disconnect from disconnecting from the network 80. The process then returns to step S4016.

If the management apparatus 70 determines that the storage area used as part of the big box in the image forming apparatus which has issued the request to disconnect can be allocated to the storage area which can be provided by another image forming apparatus in the group to which the above image forming apparatus belongs, the process advances to step S4022.

In step S4022, the management apparatus 70 instructs the image forming apparatus that has issued the request to disconnect to transfer the data stored in its storage area used as part of the big box to the preliminary area in another image forming apparatus in the group to which the above image forming apparatus belongs.

In step S4024, the management apparatus 70 detects the end of transfer of the data stored in the storage area used as part of the big box in the image forming apparatus that has issued the request to disconnect.

When the management apparatus 70 detects the end of transfer of the data stored in the storage area used as part of the big box in the image forming apparatus which has issued the request to disconnect, the process advances to step S4026.

In step S4026, the management apparatus 70 permits the image forming apparatus that has issued the request to disconnect to disconnect from the network 80.

In step S4028, the management apparatus 70 updates the management table by reflecting the ratio between the use area and the preliminary area in each of the image forming apparatuses 10 to 50 which is changed by the processing in steps S4016, S4018, S4022, S4024, and S4026. The process returns to step S4016.

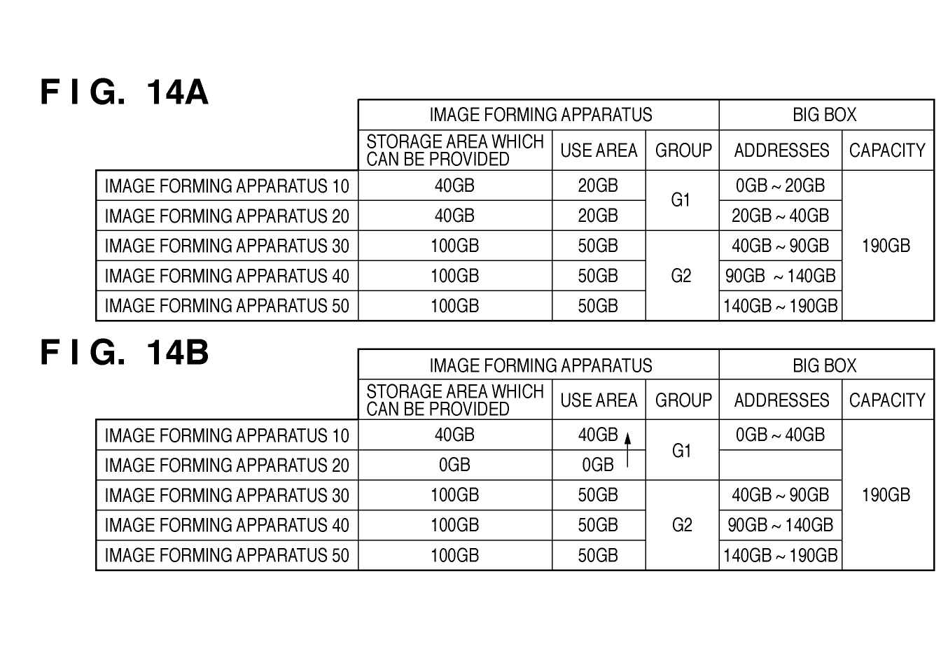

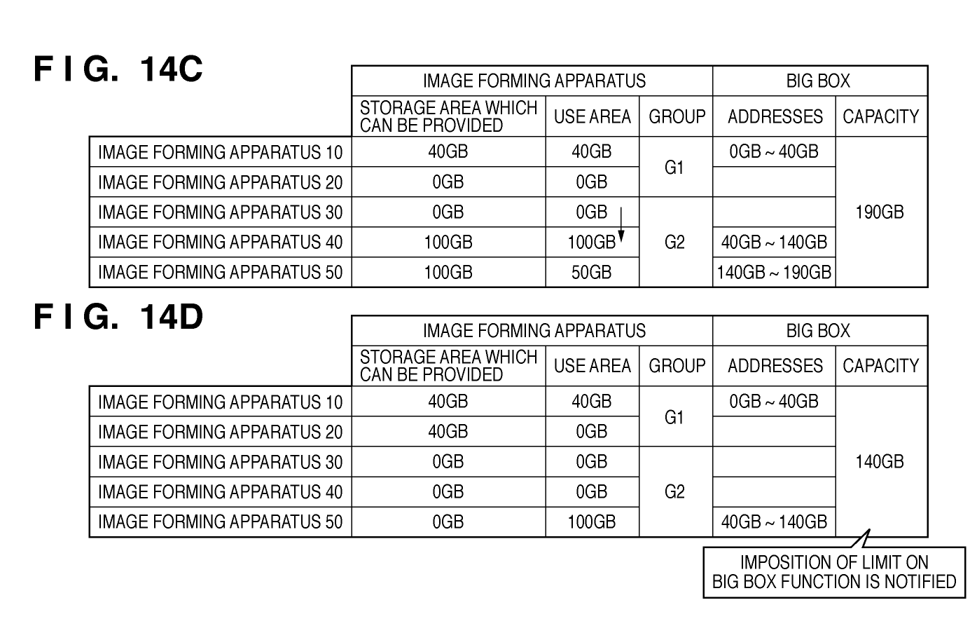

FIGS. 14A to 14D are views each showing an example of a management table created and updated by the management apparatus 70. The management table shown in each of FIGS. 14A to 14D indicates the storage area (capacity) which can be provided as part of the big box, the use area (capacity), the group to which the corresponding apparatus belongs, the addresses in the big box, and the capacity of the big box in each of the image forming apparatuses 10 to 50.

FIG. 14A shows the management table created first. Referring to FIG. 14A, since the storage area which can be provided by each of the image forming apparatuses 10 and 20 is 40 GB, and the storage area which can be provided by each of the image forming apparatuses 30 to 50 is 100 GB, it is possible to form a big box having a capacity of 380 GB. In this embodiment, however, the capacity of the big box is set to 190 GB, the use area in each of the image forming apparatuses 10 and 20 is set to 20 GB, and the use area in each of the image forming apparatuses 30 to 50 is set to 50 GB. Note that each remaining storage area (20 GB in the image forming apparatuses 10 and 20, and 50 GB in the image forming apparatuses 30 to 50) is set as a preliminary area. In addition, the image forming apparatuses 10 and 20 which can provide storage areas of 40 GB are formed into a group G1, and the image forming apparatuses 30 to 50 which can provide storage areas of 100 GB are formed into a group G2.

FIG. 14B shows the management table updated when the image forming apparatus 20 is disconnected from the network 80. Referring to FIG. 14B, the storage area (20 GB) used as part of the big box in the image forming apparatus 20 is allocated to the preliminary area (20 GB) in the image forming apparatus 10 belonging to the same group G1 as that of the image forming apparatus 20. Obviously, therefore, the capacity of the big box is maintained at 190 GB.

FIG. 14C shows the management table updated when the image forming apparatus 30 is disconnected from the network 80, in addition to the image forming apparatus 20. Referring to FIG. 14C, the storage area (50 GB) used as part of the big box in the image forming apparatus 30 is allocated to the preliminary area (50 GB) in the image forming apparatus 40 belonging to the same group G2 as that of the image forming apparatus 30. Obviously, therefore, the capacity of the big box is maintained at 190 GB.

FIG. 14D shows the management table in a case in which the image forming apparatus 40 is disconnected from the network 80, in addition to the image forming apparatuses 20 and 30. Referring to FIG. 14D, only part (50 GB) of the storage area (100 GB) used as part of the big box in the image forming apparatus 40 can be allocated to the preliminary area (20 GB) in the image forming apparatus 10 belonging to the same group G2 as that of the image forming apparatus 40. Therefore, the capacity of the big box becomes 140 GB. That is, the capacity cannot be maintained at 190 GB. In such a case, the management apparatus 70 prohibits the image forming apparatus 40 from disconnecting from the network 80, and hence does not update the management table shown in FIG. 14D in practice.

In this manner, it is possible to group image forming apparatuses (their storage apparatuses) in accordance with the capacities of the storage areas which can be provided as a big box, and to control the connection of each image forming apparatus in each group to a network. This makes it possible to easily decide an image forming apparatus to which the storage area used as part of the big box in the image forming apparatus that has issued a request to disconnect is allocated, thus facilitating control of the connection of each image forming apparatus to the network.

It is preferable to decide the ratio between a use area and a preliminary area in each of the image forming apparatuses 10 to 50 in accordance with the number of image forming apparatuses forming a big box. This can implement a big box with the maximum capacity.

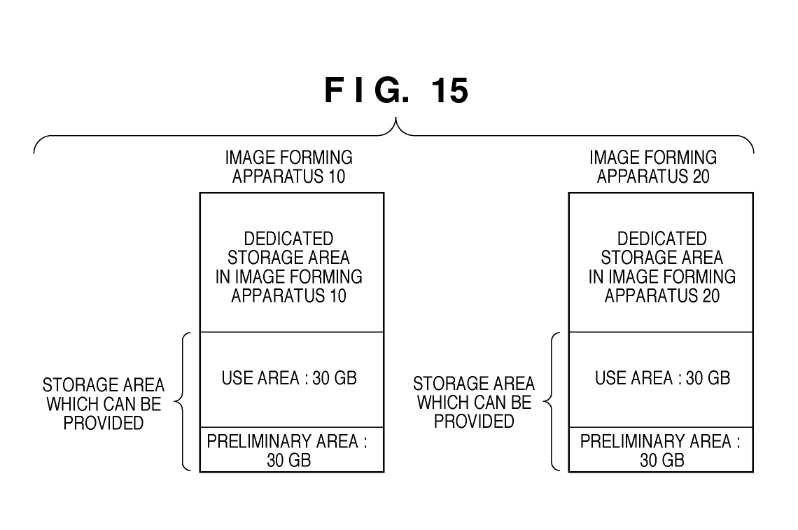

A case in which the two image forming apparatuses 10 and 20 form a big box will be described with reference to FIG. 15. Assume that the image forming apparatuses 10 and 20 each can provide a storage area having a capacity of 60 GB. In this case, assume that the capacity (60 GB) of the storage area which can be provided by each of the image forming apparatuses 10 and 20 is divided by the number (two) of image forming apparatuses (their storage apparatuses) forming a big box to set the capacity of the preliminary area in each of the image forming apparatuses 10 and 20 to 30 GB. In addition, the capacity of the use area in each of the image forming apparatuses 10 and 20 is set to 30 GB by subtracting the capacity (30 GB) of the preliminary area from the storage capacity (60 GB) which can be provided.

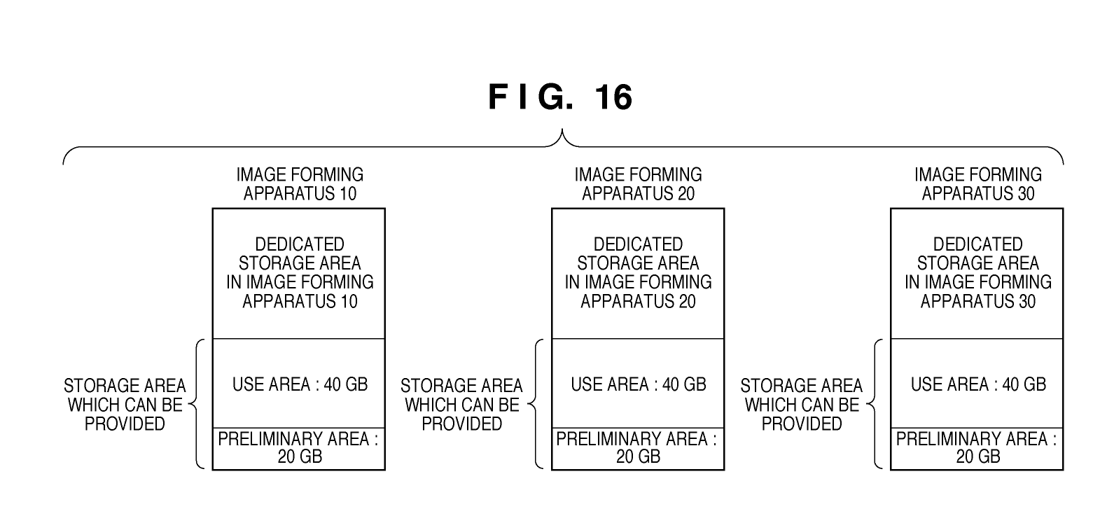

A case in which the three image forming apparatuses 10, 20, and 30 form a big box will be described with reference to FIG. 16. Assume that the image forming apparatuses 10, 20, and 30 each can provide a storage area having a capacity of 60 GB. In this case, assume that the capacity (60 GB) of the storage area which can be provided by each of the image forming apparatuses 10, 20, and 30 is divided by the number (three) of image forming apparatuses forming a big box to set the capacity of the preliminary area in each of the image forming apparatuses 10, 20, and 30 to 20 GB. In addition, the capacity of the use area in each of the image forming apparatuses 10, 20, and 30 is set to 40 GB by subtracting the capacity (20 GB) of the preliminary area from the storage capacity (60 GB) which can be provided.

In addition, in this embodiment, the management apparatus 70 manages the image forming apparatuses 10 to 50. However, the image forming apparatuses 10 to 50 each may have the function of the management apparatus 70. In this case, priorities are set for the image forming apparatuses each having the function of the management apparatus 70, and an image forming apparatus in the normal state manages the remaining image forming apparatuses in accordance with the priorities. When an image forming apparatus that is managing other image forming apparatuses issues a request to disconnect from a network, the authorization to manage other image forming apparatuses is transferred to an image forming apparatus having the next highest priority.

Note that the present invention is not limited to the case in which a plurality of image forming apparatuses form one virtual storage area, and can also be applied to a case in which a plurality of other apparatuses having storage areas form one virtual storage area on a network.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent application No. 2009-055724 filed on Mar. 9, 2009, which is hereby incorporated by reference herein in its entirety.

What is claimed is:

1. A management apparatus that manages a plurality of storage apparatuses connected to a network, the apparatus comprising:
a management unit configured to form one virtual storage area on the network from storage areas which are configured to be respectively provided by said plurality of storage apparatuses and manage the virtual storage area;
a detection unit configured to detect a stop request to stop at least one of said plurality of storage apparatuses from providing a storage area managed as part of the virtual storage area;
a determination unit configured to determine, when said detection unit detects the stop request, whether a storage area provided as part of the virtual storage area by said storage apparatus which has issued the stop request is configured to be allocated to a storage area which is configured to be provided by another storage apparatus; and
a control unit configured to perform control to permit said storage apparatus which has issued the stop request to stop providing the storage area when said determination unit determines that the storage area is configured to be allocated and to prohibit said storage apparatus which has issued the stop request from stopping providing the storage area when said determination unit determines that the storage area is not configured to be allocated.

2. The apparatus according to claim 1, wherein said plurality of storage apparatuses each include a use area which is used as part of the virtual storage area when all said plurality of storage apparatuses provide storage areas managed as the virtual storage area, and a preliminary area which is configured to be used as part of the virtual storage area when at least one of said plurality of storage apparatuses stops providing a storage area managed as part of the virtual storage area.

3. The apparatus according to claim 2, further comprising an instruction unit configured to issue an instruction to transfer data stored in a storage area provided as part of the virtual storage area in said storage apparatus which has issued the stop request to the preliminary area in the other storage apparatus, when said determination unit determines that the storage area is configured to be allocated,
wherein said control unit performs control to permit said storage apparatus which has issued the stop request to stop providing the storage area, when transfer of the data is complete.

4. The apparatus according to claim 2, wherein said determination unit determines that the storage area is configured to be allocated, when a capacity of a storage area provided as part of the virtual storage area by said storage apparatus which has issued the stop request is not more than a capacity of the preliminary area in the other storage apparatus, and determines that the storage area is not configured to be allocated, when the capacity of the storage area provided as part of the virtual storage area by said storage apparatus which has issued the stop request is larger than the capacity of the preliminary area in the other storage apparatus.

5. The apparatus according to claim 2, further comprising a setting unit configured to set a ratio between the use area and the preliminary area in accordance with the number of said plurality of storage apparatuses.

6. The apparatus according to claim 2, further comprising a grouping unit configured to divide said plurality of storage apparatuses into groups such that capacities of storage areas which are configured to be provided by storage apparatuses in each group are equal or similar to each other,
wherein said determination unit determines whether a storage area provided as part of the virtual storage area in said storage apparatus which has issued the stop request is configured to be allocated to a preliminary area in another storage apparatus in the group to which said storage apparatus belongs.

7. A system comprising a plurality of storage apparatuses connected to a network and a management apparatus that manages said plurality of storage apparatuses,
said management apparatus comprising
a management unit configured to form one virtual storage area on the network from storage areas which are configured to be respectively provided by said plurality of image forming apparatuses and manage the virtual storage area,
a detection unit configured to detect a stop request to stop at least one of said plurality of storage apparatuses from providing a storage area managed as part of the virtual storage area,
a determination unit configured to determine, when said detection unit detects the stop request, whether a storage area provided as part of the virtual storage area by said storage apparatus which has issued the stop request is configured to be allocated to a storage area which is configured to be provided by another storage apparatus, and
a control unit configured to perform control to permit said storage apparatus which has issued the stop request to stop providing the storage area when said determination unit determines that the storage area is configured to be allocated and to prohibit said storage apparatus which has issued the stop request from stopping providing the storage area when said determination unit determines that the storage area is not configured to be allocated.

8. A control method for a management apparatus that manages a plurality of storage apparatuses connected to a network, the method comprising the steps of:
forming one virtual storage area on the network from storage areas which are configured to be respectively provided by the plurality of storage apparatuses and managing the virtual storage area;
detecting a stop request to stop at least one of the plurality of storage apparatuses from providing a storage area managed as part of the virtual storage area;
determining, when the stop request is detected in the step of detecting, whether a storage area provided as part of the virtual storage area by the storage apparatus which has issued the stop request is configured to be allocated to a storage area which is configured to be provided by another storage apparatus; and
performing control to permit the storage apparatus which has issued the stop request to stop providing the storage area when it is determined in the step of determining that the storage area is configured to be allocated and to prohibit the storage apparatus which has issued the stop request from stopping providing the storage area when it is determined in the step of determining that the storage area is not configured to be allocated.

9. A computer-readable recording medium which records a program for causing a computer to execute a control method for a management apparatus which manages a plurality of storage apparatuses connected to a network, the program causing the computer to execute the steps of:
forming one virtual storage area on the network from storage areas which are configured to be respectively provided by the plurality of storage apparatuses and managing the virtual storage area;
detecting a stop request to stop at least one of the plurality of storage apparatuses from providing a storage area managed as part of the virtual storage area;
determining, when the stop request is detected in the step of detecting, whether a storage area provided as part of the virtual storage area by the storage apparatus which has issued the stop request is configured to be allocated to a storage area which is configured to be provided by another storage apparatus; and
performing control to permit the storage apparatus which has issued the stop request to stop providing the storage area when it is determined in the step of determining that the storage area is configured to be allocated and to prohibit the storage apparatus which has issued the stop request from stopping providing the storage area when it is determined in the step of determining that the storage area is not configured to be allocated.
